(19) United States
(12) Patent Application Publication
(10) Pub. No.: US 2013/0346810 A1
(43) Pub. Date: Dec. 26, 2013

(54) USE OF APPLICATION-LEVEL CONTEXT INFORMATION TO DETECT CORRUPTED DATA IN A STORAGE SYSTEM

(71) Applicant: NetApp. Inc., Sunnyvale, CA (US)

(72) Inventors: Jeffrey S. Kimmel, Chapel Hill, NC (US); Sunitha S. Sankar, Cupertino, CA (US); Rajesh Sundaram, Mountain View, CA (US); Nitin Muppalaneni, Santa Clara, CA (US); Emily W. Eng, San Francisco, CA (US); Eric C. Hamilton, Durharn, NC (US)

(21) Appl. No.: 13/918,428

(22) Filed: Jun. 14, 2013

Related U.S. Application Data
(63) Continuation of application No. 10/951,644, filed on Sep. 27, 2004, now abandoned.

(51) Int. Cl. G06F 11/07

(52) U.S. Cl. CPC G06F 11/073
USPC 714/54

(57) ABSTRACT

A storage system, such as a file server, receives a request to perform a write operation that affects a data block. In response, the storage system writes to a storage device the data block together with context information which uniquely identifies the write operation with respect to the data block. When the data block is subsequently read from the storage device together with the context information, the context information that was read with the data block is used to determine whether a previous write of the data block was lost.

### CROSS-REFERENCES TO RELATED APPLICATIONS

This application is a continuation of co-pending U.S. application Ser. No. 10/951,644, filed Sep. 27, 2004 which is also related to U.S. patent application Ser. No. 09/696,666, filed on Oct. 25, 2000 and entitled, “Block-Appended Checksums.” and U.S. patent application Ser. No. 10/152,448, filed on May 21, 2002 and entitled, “System and Method for Emulating Block-Appended Checksums on Storage Devices by Sector Stealing”.

### FIELD OF THE INVENTION

At least one embodiment of the present invention pertains to storage systems, and more particularly, to a method and apparatus for using application-level context information to detect corrupted data in a storage system.

### BACKGROUND

A storage server is a special-purpose processing system used to store and retrieve data on behalf of one or more client processing systems (“clients”). A storage server can be used for many different purposes, such as to provide multiple users with access to shared data or to backup mission critical data.

A file server is an example of a storage server. A file server operates on behalf of one or more clients to store and manage shared files in a set of mass storage devices, such as magnetic or optical storage based disks or tapes. The mass storage devices may be organized into one or more volumes of Redundant Array of Inexpensive Disks (RAID). Another example of a storage server is a device which provides clients with block-level access to stored data, rather than file-level access, or a device which provides clients with both file-level access and block-level access.

In a large scale storage system, it is inevitable that data will become corrupted from time to time. Consequently, virtually all modern storage servers implement various techniques for detecting and correcting errors in data. RAID schemes, for example, include built-in techniques to detect and, in some cases, to correct corrupted data. Error detection and correction is often performed by using a combination of checksums and parity. Error correction can also be performed at a lower level, such as at the disk level.

In file servers and other storage systems, occasionally a write operation executed by the server may fail to be committed to the physical storage media, without any error being detected. The write is essentially “lost” somewhere between the server and the storage media. This type of the fault is typically caused by faulty hardware in a disk drive or in a disk drive adapter dropping the write silently without reporting any error. It is desirable for a storage server to be able to detect and correct such “lost writes” any time data is read.

While modern storage servers employ various error detection and correction techniques, these approaches are inadequate for purposes of detecting this type of error. For example, in one well-known class of file server, files sent to the file server for storage are first broken up into 4 KByte blocks, which are then formed into groups that are stored in a “stripe” spread across multiple disks in a RAID array. Just before each block is stored to disk, a checksum is computed for that block, which can be used when that block is subsequently read to determine if there is an error in the block. In one known implementation, the checksum is included in a 64 Byte metadata field that is appended to the end of the block when the block is stored. The metadata field also contains: a volume block number (VBN) which identifies the logical block number where the data is stored (since RAID aggregates multiple physical drives as one logical drive); a disk block number (DBN) which identifies the physical block number within the disk in which the block is stored; and an embedded checksum for the metadata field itself This error detection technique is referred to as “block-appended checksum” to facilitate discussion.

Block-appended checksum can detect corruption due to bit flips, partial writes, sector shifts and block shifts. However, it cannot detect corruption due to a lost block write, because all of the information included in the metadata field will appear to be valid even in the case of a lost write.

Parity in single parity schemes such as RAID-4 or RAID-5 can be used to determine whether there is a corrupted block in a stripe due to a write. This can be done by comparing the stored and computed values of parity, and if they do not match, the data may be corrupt. However, in the case of single parity schemes, while a single ad block can be reconstructed from the parity and remaining data blocks, there is not enough information to determine which disk contains the corrupted block in the stripe. Consequently, the corrupted data block cannot be recovered using parity.

With RAID Double Parity (RAID-DP), a technique invented by Network Appliance Inc. of Sunnyvale, California, a single bad block in a stripe can be detected and corrected, or two bad blocks can be detected without correction. It is desirable, to be able to detect and correct an error in any block anytime there is a read of that block. However, checking parity in both RAID-4 and RAID-DP is “expensive” in terms of computing resources, and therefore is normally only done when operating in a “degraded mode”, i.e., when an error has been detected, or when scrubbing parity (normally, the parity information is simply updated when a write is done). Hence, using parity to detect a bad block on file system reads is not a practical solution, because it can cause potentially severe performance degradation.

Read-after-write is another known mechanism to detect data corruption. In that approach, a data block is read back immediately after writing it and is compared to the data that was written. If the data read back is not the same as the data that was written, then this indicates the write did not make it to the storage block. Read-after-write can reliably detect corrupted block due to lost writes, however, it also has a severe performance impact, because every write operation is followed by a read operation.

What is needed, therefore, is a technique for detecting lost writes in a storage system, which overcomes the shortcomings of the above-mentioned approaches.

### SUMMARY OF THE INVENTION

The present invention includes a method which includes, in response to a request to perform a write operation that affects a data block, writing to a storage device the data block together with context information which uniquely identifies the write operation with respect to the data block. The method further includes reading the data block and the context information together from the storage device, and using the context information that was read with the data block to determine whether the data block is valid.

The invention further includes a system and apparatus that can perform such a method.

Other aspects of the invention will be apparent from the accompanying figures and from the detailed description which follows.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 shows a network environment that includes a file server which implements the invention;

FIG. 2 is a block diagram showing the architecture of a file server that can implement the invention; and

FIGS. 3A and 3B are block diagrams showing the operating system of a file server according to two different embodiments of the invention;

FIG. 4 illustrates how a file is broken up into blocks for storage in a storage array;

FIG. 5 illustrates a hierarchy in which a data block is associated with an inode through one or more indirect blocks; and

FIG. 6 shows block-appended metadata that includes context information generated by the file system,

### DETAILED DESCRIPTION

A method and apparatus for efficiently detecting lost writes and other similar errors in a storage system are described. As described in greater detail below, in certain embodiments of the invention the method includes using file system context information about stored data to detect lost writes. More specifically, file system context information about a data block is stored in a metadata entry appended to the data block when the data block is written. Later, when the data block is read from storage, the context information stored in the metadata entry is compared with the corresponding context information from the file system for the data block. Any mismatch between the context information stored in the metadata entry and the corresponding context information from the file system indicates that the data in the storage block has not been updated due to lost write, and is therefore invalid, in which case the data can be reconstructed using parity and the data in the remaining disks. One advantage of this technique is that it allows detection of a lost write anytime the affected data block is read.

This technique can be implemented with a file system that does not allow the same physical storage location to be overwritten when a data block is modified, such as the WAFL file system made by Network Appliance, Inc. In such a system, the technique introduced herein has no adverse performance impact, because the context information must be read anyway by the file system from each indirect block associated with a data block on every write of that data block. Therefore, simply writing this context information with the data block does not degrade performance.

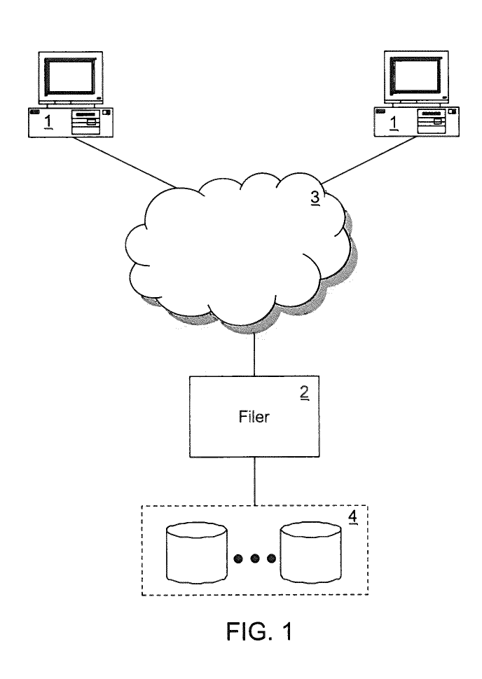

As noted, the error detection technique introduced herein can be implemented in a file server. FIG. 1 shows a simple example of a network environment which incorporates a file server 2. Note, however, that the error detection technique introduced herein is not limited to use in traditional file servers. For example, the technique can be adapted for use in other types of storage systems, such as storage servers which provide clients with block-level access to stored data or processing systems other than storage servers.

The file server 2 in FIG. 1 is coupled locally to a storage subsystem 4 which includes a set of mass storage devices, and to a set of clients 1 through a network 3, such as a local area network (LAN). Each of the clients 1 may be, for example, a conventional personal computer (PC), workstation, or the like. The storage subsystem 4 is managed by the file server 2. The file server 2 receives and responds to various read and write requests from the clients 1, directed to data stored in or to be stored in the storage subsystem 3. The mass storage devices in the storage subsystem 4 may be, for example, conventional magnetic disks, optical disks such as CD-ROM or DVD based storage, magneto-optical (MO) storage, or any other type of non-volatile storage devices suitable for storing large quantities of data.

The file server 2 may have a distributed architecture; for example, it may include a separate N-(“network”) blade and D-(disk) blade (not shown). In such an embodiment, the N-blade is used to communicate with clients 1, while the D-blade includes the file system functionality and is used to communicate with the storage subsystem 4. The N-blade and D-blade communicate with each other using an internal protocol. Alternatively, the file server 2 may have an integrated architecture, where the network and data components are all contained in a single box. The file server 2 further may be coupled through a switching fabric to other similar file servers (not shown) which have their own local storage subsystems. In this way, all of the storage subsystems can form a single storage pool, to which any client of any of the file servers has access.

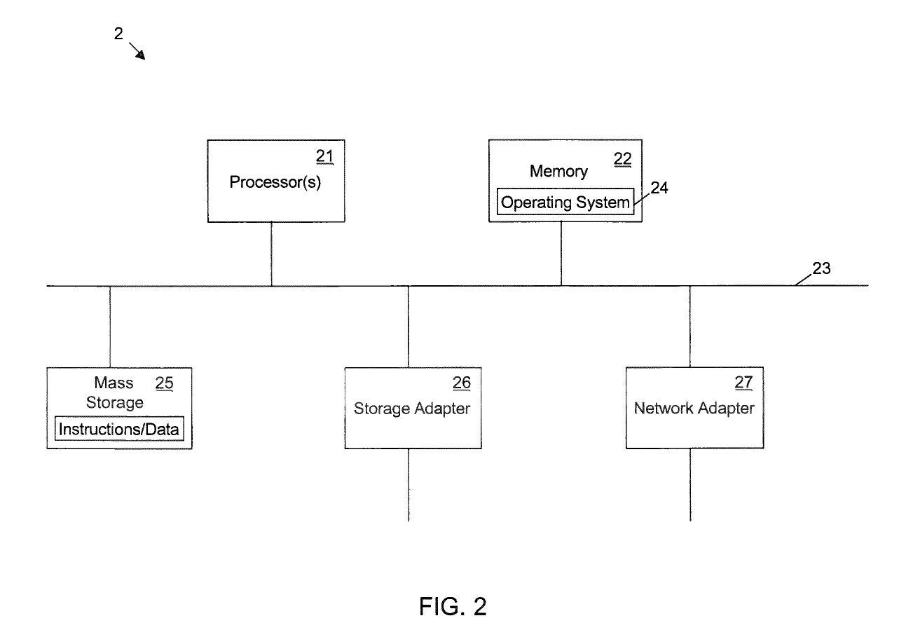

FIG. 2 is a block diagram showing the architecture of the file server 2, according to certain embodiments of the invention. Certain standard and well-known components which are not germane to the present invention may not be shown. The file server 2 includes one or more processors 21 and memory 22 coupled to a bus system 23. The bus system 23 shown in FIG. 2 is an abstraction that represents any one or more separate physical buses and/or point-to-point connections, connected by appropriate bridges, adapters and/or controllers. The bus system 23, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processors 21 are the central processing units (CPUs) of the file server 2 and, thus, control the overall operation of the file server 2. In certain embodiments, the processors 21 accomplish this by executing software stored in memory 22. A processor 21 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 22 is or includes the main memory of the file server 2. Memory represents any form of random access memory (RAM), read-only memory (ROM), flash memory, or the like, or a combination of such devices. Memory 22 stores, among other things, the operating system 24 of the file server 2, in which the error detection techniques introduced above can be implemented.

Also connected to the processors 21 through the bus system 23 are one or more internal mass storage devices 25, a storage adapter 26 and a network adapter 27. Internal mass storage devices 25 may be or include any conventional medium for storing large volumes of data in a non-volatile manner, such as one or more magnetic or optical based disks. The storage adapter 26 allows the file server 2 to access the storage subsystem 4 and may be, for example, a Fibre Channel adapter or a SCSI adapter. The network adapter 27 provides the file server 2 with the ability to communicate with remote devices, such as the clients 1, over a network and may be, for example, an Ethernet adapter.

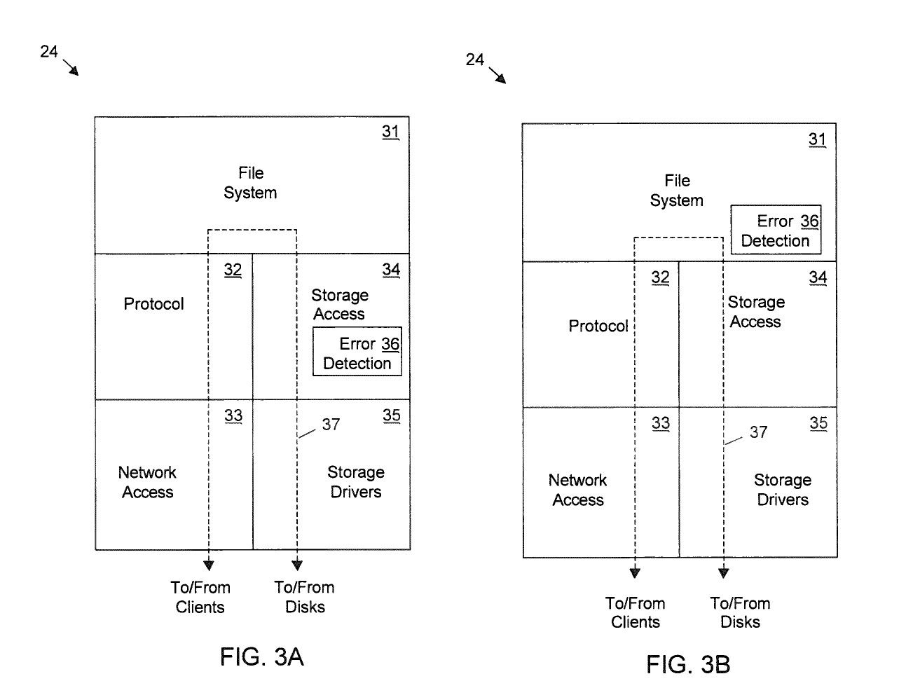

FIGS. 3A and 3B show an example of the operating system 24 of the file server 2, for two different embodiments. As shown, the operating system 24 includes several modules, or “layers”. These lavers include a file system 31. The file system 31 is application-layer software that keeps track of the directory structure (hierarchy) of the data stored in the storage subsystem 4 and manages read/write operations on the data executes read/write operations on the disks in response to client requests). Logically “under” the file system 31, the operating system 24 also includes a protocol layer 32 and an associated network access layer 33, to allow the file server 2 to communicate over the network 3 (e.g., with clients 1). The protocol 32 layer implements one or more of various higher-level network protocols, such as Network File System (NFS), Common Internet File System (CIFS), Hypertext Transfer Protocol (HTTP) and/or Transmission Control Protocol Internet Protocol (TCP/IP). The network access layer 143 includes one or more drivers which implement one or more lower-level protocols to communicate over the network, such as Ethernet.

Also logically under the file system 31, the operating system 24 includes a storage access layer 34 and an associated storage driver layer 35, to allow the file server 2 to communicate with the storage subsystem 4. The storage access layer 34 implements a higher-level disk storage protocol, such as RAID, while the storage driver layer 35 implements a lower-level storage device access protocol, such as Fibre Channel Protocol (FCP) or SCSI. To facilitate description, it is henceforth assumed herein that the storage access layer 34 implements a RAID protocol, such as RAID-4, and therefore may alternatively be referred to as RAID layer 34.

Also shown in FIGS. 3A and 3B is the path 37 of data flow, through the operating system 24, associated with a read or write operation.

As shown in FIG. 3A, in one embodiment of the invention the storage access layer 34 includes an error detection module 36, which performs operations associated with the error detection technique introduced herein. More specifically, during a write operation, the storage access layer 34 receives from the file system 31 a data block to be stored with metadata appended to it, including a checksum. The storage access layer 34 also receives context information about the data block from the file system 31. The error detection module 36 puts that context information into the metadata field appended to the data block, before the storage access layer 34 passes the data to the storage driver layer 35. When that data block is subsequently read, the error detection module 36 extracts the context information tom the metadata field appended to the data block and compares the extracted context information with the context information which the file system 31 currently has for that block. If the two sets of context information do not match, the last write to the block is determined to be “lost”, such that the block is invalid. This embodiment, in which the error detection module resides within the storage access layer 34, is efficient because the storage access layer 34 is normally the entity which will perform recovery if an error is detected (at least in the case of RAID). In another embodiment, however, shown in FIG. 3B, the error detection module 36 resides in the file system 31 and performs essentially the same functions as in the embodiment of FIG. 3A. In still other embodiments, the error detection module 36 can be distributed between two or more layers, such as between the file system 31 and the storage access layer 34, or it can be a separate and distinct layer.

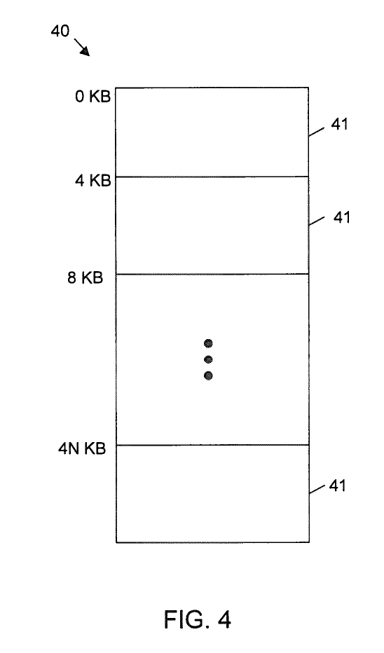

The error detection technique introduced herein will now be described in greater detail with reference to FIGS. 4 through 7. Referring to FIG. 4, each file 40 sent to the file server 2 for storage is broken up by the file system 31 into 4 Kbyte blocks 41, which are then stored in a “stripe” spread across multiple disks in the storage subsystem 4. The storage subsystem 4 is assumed to be a RAID array for purposes of description. As used herein, the term “block” can mean any chunk of data which the file system 31 is capable of recognizing and manipulating as a distinct entity. While in this description a block is described as being a 4 Kbyte chunk, in other embodiments of the invention a block may have a different size.

The technique introduced herein, according to certain embodiments, builds upon the “block-appended checksum” technique. Just before each block is stored to disk, a checksum is computed for the block, which can be used during a subsequent read to determine if there is an error in the block. The checksum is included in a metadata field that is appended to the end of the block just before the block is stored to disk. In certain embodiments, the metadata field appended to each 4 Kbyte block is 64 bytes long. The metadata field also contains a volume block number (VBN), which identifies the logical disk in which the block is stored, a disk block number (DBN), which identifies the physical block number within the VBN in which the block is stored, and an embedded checksum for the block-appended checksum itself.

In accordance with the invention, context information from the file system is also included in the metadata field. The context information is information which describes the context of the data block. In particular, the context information uniquely identifies a specific write operation relative to the block being stored, i.e., information which can be used to distinguish the write of that block from a prior write of that block.

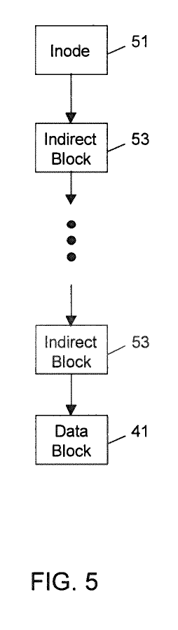

In certain embodiments, the file server 2 uses inodes to keep track of stored data. For purposes of this description, the term “inode” is used here in essentially the same manner as in a UNIX-based system. More specifically, an inode is a data structure, stored in an inode file, that keeps track of which logical blocks of data in the storage subsystem 4 are used to store each file. Normally, each stored file is represented by a corresponding inode. A data block can be referenced directly by an inode. More commonly, however, as shown in FIG. 5, a particular data block 41 is referenced by an inode 51 indirectly, rather than directly. In that case, the inode 51 of the file in which the data block 41 resides is the root of a hierarchical structure of blocks, including the data block 41 and one or more indirect blocks 53. The inode 52 points to an indirect block 53, which points to the actual data block 41 or to another indirect block 53. An indirect block 53 is a block which points to another block rather than containing actual file data. Every data block in a file is referenced in this way from the inode.

According to certain embodiments, the context information generated by the file system 31 is stored in the block appended metadata associated with each stored block. In other embodiments, however, the context information may be incorporated into the data block itself To facilitate description, however, the remainder of this description assumes that the context information is stored in the block-appended metadata field.

In certain embodiments, the context information includes the file block number (FEN) of the data block and the inode number of the data block. The FBN is the offset of the data block within the file to which the data block belongs. The FBN and the inode number may both be 4 byte words, for example. The context information may also include a generation number for the data block, as explained below.

The context information for a data block should uniquely identify a particular write to the data block. In certain embodiments, the file system 31 does not allow the same physical storage location to be overwritten when a data block is modified; instead, the data block is written to a different physical location each time it is modified. In such embodiments, the FBN and inode number are sufficient to uniquely identify the data block and, moreover, to uniquely identify a particular write of that data block.

Note that in a real storage system, the number of blocks is not unlimited. That means that sooner or later the storage system will have to [re]use blocks that it used in the past but freed as the changed data was written to a different disk block. In such systems (the WAFL file system made by Network Appliance Inc. is one example), the probability of a block being reused for the exact same context can be small enough for the technique described here to be useful.

If the implementation permits data blocks to be overwritten in place, it is necessary to use additional context information to uniquely identify a particular write of a particular data block. In such implementations, the generation number can be used for that purpose. The generation number is an increasing counter used to determine how many times the data block has been written in place. Note, however, that use of a generation number may adversely impact performance, since all indirect blocks must be updated each time the generation number is updated.

The file system 31 manages the context information of the data and passes that information down to the storage access (e.g., RAID) layer 34 with the data on read and write operations. The storage access layer 34 stores the context information in the block-appended metadata field on writes. On reads the storage access layer 34 extracts the context information from the metadata field and, in certain embodiments, compares it with corresponding context information passed down by the file system 31 for that data block. In other embodiments, the storage access layer 34 simply passes the extracted context information up to the file system 31, which does the comparison. In either case, if there is a mismatch, the data block is determined to be corrupted. In that case, the data block is reconstructed, and the reconstructed data block is written back to disk.

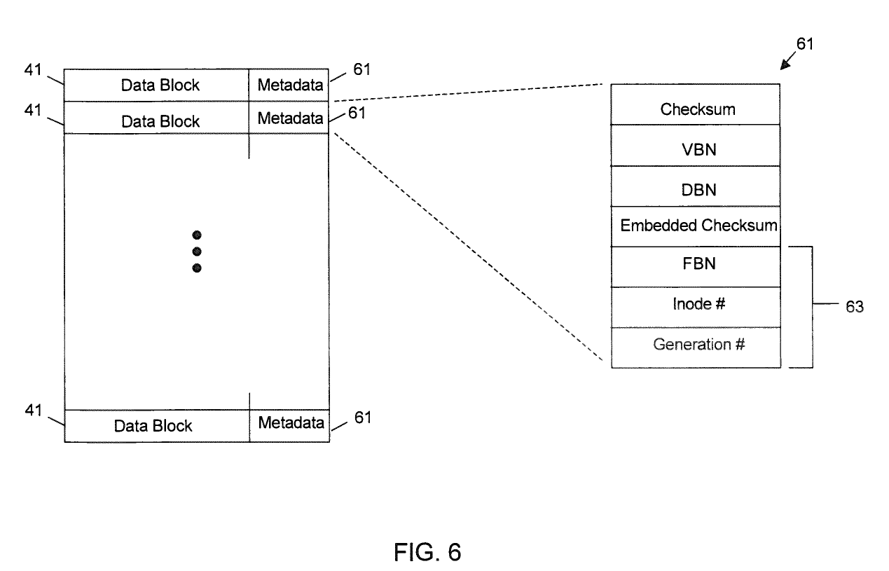

As shown in FIG. 6, data blocks 41 are stored on disk with their corresponding metadata fields 61 appended to them. Each metadata field 61 includes a checksum for the data block, the VBN and DBN of the data block, and an embedded checksum for the metadata field itself In addition, in accordance with the invention each metadata field also includes file system context information 63 for that data block, i.e., the FBN, inode number, and generation number of the data block.

In certain situations in a file system it may be necessary to move all or some of the blocks of one inode to another inode. This may be done for any of various reasons that are not germane to the invention, such as for file truncation purposes. If a file or a portion thereof is moved to another inode, the inode number stored in the metadata field 61 will become invalid. Consequently, in embodiments which permit the reassignment of data blocks from one inode to another, an artificial identifier, referred to as bufftree ID, is substituted for the mode number in the metadata field. For this purpose, what is needed is an identifier that is associated with the blocks of an inode rather than the inode itself. The bufftree ID can be a random number, generated and stored inside the inode when the inode is allocated its first block. When an mode inherits some or all of the blocks from another inode, it also inherits the bufftree ID of that inode. Hence, the bufftree ID stored in the metadata field 61 for a given data block will remain valid even if the data block is moved to a new inode.

Thus, a method and apparatus for efficiently detecting lost vanes in a storage system have been described. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method comprising:
in response to a request to perform a read operation on a data block, reading, by a storage access layer executing on a processor in a file server, the data block and context information together from a storage device, the context information stored on the storage device with the data block and uniquely identifying a last write operation with respect to the data block;
reading, by a file system executing on the processor, context information for the data block from an inode corresponding to the data block; and
determining that a write of the data block was lost when the context information stored on the storage device does not match the context information stored in the inode.

2. The method of claim 1 further comprising:
in response to a request to perform a write operation that affects the data block, writing to the storage device, by the storage access layer, the data block together with the context information that uniquely identifies the write operation.

3. The method of claim 2, further comprising:
receiving, by the storage access layer from the file system, the context information to be stored together with the data block on the storage device.

4. The method of claim 2, further comprising, prior to writing the data block and the context information together to the storage device:
appending, by the storage access layer, metadata for the data block to the data block, the metadata including the context information and a checksum for use in detecting an error in the data block.

5. The method of claim 2, further comprising, prior to writing the data block and the context information together to the storage device:
incorporating the context information into the data block.

6. The method of claim 1, wherein said determining that a write of the data block is lost is performed by the file system.

7. The method of claim 1, further comprising:
passing, by the storage access layer to the file system, the context information stored on the storage device.

8. The method of claim 1, wherein said determining that a write of the data block is lost is performed by the storage access layer.

9. The method of claim 1, wherein the storage access layer is a RAID (Redundant Array of Inexpensive Disks) layer.

10. The method of claim 1, wherein the context information is generated by the file system.

11. The method of claim 1, wherein the context information includes a file block number identifying a block within a file to which the data block corresponds.

12. The method of claim 1, wherein the context information includes an identifier for the inode.

13. The method of claim 1, wherein the context includes a bufftree identifier associated with blocks of the inode.

14. The method of claim 1, wherein the context information includes a generation indication indicating a number of times the data block has been written.

15. A method comprising:
storing in a storage device, by a storage access module executing on a processor in a file server, a data block together with file system context information when a write operation is completed for the data block, the file system context information generated by a file system executing in the processor, wherein a lost write of the data block is subsequently detected by comparing the file system context information stored on the storage device to file system context information retrieved by the file system from an entry in a hierarchical file system data structure corresponding to the data block.

16. The method of claim 15, wherein the file system context information includes a file block number identifying a block within a file to which the data block corresponds.

17. The method of claim 15, wherein the file system context information includes an identifier for the entry in the hierarchical file system data structure.

18. The method of claim 15, wherein the file system context information includes a bufftree identifier for blocks associated with the entry in the hierarchical file system data structure.

19. The method of claim 15, wherein the file system context information includes a generation indication indicating a generation of the data block.

20. The method of claim 15, wherein the file system context information is incorporated into the data block when stored in the storage device.

21. The method of claim 15, wherein the file system context information is appended to the data block when stored in the storage device.

22. The method of claim 15 further comprising, prior to said storing the file system context information and the data block:
appending metadata about the data block to the data block, the metadata including the file system context information and a checksum for use in detecting an error in the data block.

23. A storage system comprising:
a file system, executing on a processor in a storage server, to maintain a hierarchical structure of data stored in RAID (Redundant Array of Inexpensive Disks) array of storage devices and to service read and write requests from one or more clients relating to data stored in the array of storage devices, the file system further to generate, in response to a request to perform a write operation, file system context information that uniquely identifies the write operation relative to a data block and to write the file system content information into the hierarchical structure;
a RAID module, executing on the processor, to control access to data stored in the array of storage devices in response to the file system, the RAID module further to receive the file system context information from the file system and to write the data block and the file system context information together to the array, and the RAID module further to respond to a read request relating to the data block by reading the data block and the file system context information together from the array; and
an error detection module, executing on the processor, to detect a lost write for the data block by comparing the file system context information for the data block read from the array with the file system context information for the data block retrieved from the hierarchical structure.

24. The storage system of claim 23, wherein the storage access module includes the file system context information in metadata appended to the data block, the metadata further including a checksum for use in detecting an error in the data block.

25. The storage system of claim 23, wherein the storage access module incorporates the file system context information into the data block.

26. The storage system of claim 23, wherein the file system context information includes a file block number identifying a block within a file to which the data block corresponds.

27. The storage system of claim 23, wherein the file system context information includes an identifier corresponding to a root of the hierarchical structure that references the data block.

28. The storage system of claim 27, wherein the identifier represents an inode for the data block.

29. The storage system of claim 27, wherein the identifier is bufftree identifier for blocks associated with an inode for the data block.

30. The storage system of claim 23, wherein the file system context information includes a generation indication indicating a number of time the data block has been written.
